(19) United States
(12) Patent Application Publication
(10) Pub. No.: US 2004/0073454 A1
(43) Pub. Date: Apr. 15, 2004

(54) System and method of portal-mediated, website-based analysis of medication dosing

(76) Inventors: John Urquhart, Palo Alto, CA (US); Pierre-Alain Gaillard, Zurich (CH); Jean-Michel Metry, Sion (CH)

Correspondence Address: BURNS, DOANE, SWECKER & MATHIS, L.L.P., P.O. Box 1404, Alexandria, VA, 22313-1404, US

(21) Appl. No.: 10/269,297

(22) Filed: Oct. 10, 2002

(51) Int. Cl. G06F 17/60

(52) U.S. Cl. 705/2

(57) ABSTRACT

The system of portal-mediated, website-based analysis of medication dosing data provides a system for recording dosing history, analyzing the dosing history data, and providing a physician with the analysis of the dosing history data, as well as advice as to the steps to take to improve the patient's compliance or to prevent its further deterioration. The system for portal-mediated, website-based analysis of medication dosing includes a package, dispenser, or organizer adapted to provide a patient with medication, and to generate dosing history data, a webserver accessible through a website and adapted to receive said dosing history data through said website via the Internet, and a processor for analyzing the received dosing history data to thereby generate analysis data.

### FIELD OF THE INVENTION

The invention relates to a system and method of analyzing medication dosing data, and more particularly, the invention relates to portal-mediated, website-based systems for analyzing data on patient compliance with a prescribed drug regimen and for providing analysis of said data and advice to the patient's caregiver(s) regarding the interpretation of the analysis in respect to the clinical impact of the patient's compliance and means for improving the patient's compliance with the prescribed drug regimen. The uses of this invention apply as well to clinical trials as they do to everyday medical practice. The uses of this invention also apply to medicines sold over-the-counter that may play a therapeutically important role in patient care, e.g., low-dose aspirin for prevention of coronary artery disease, and the like.

### DESCRIPTION OF THE RELATED ART

When a physician prescribes medication in a non-hospital setting, i.e. ambulatory care, or when an over-the-counter medication is sold, reliance is placed on the patient to comply with the dosing instructions. Unfortunately, even in the case of life-threatening illness, patient compliance with the prescribed dosing regimen is often negligent. It has been found that a substantial proportion of patients take less than the prescribed amount of medication and that many of such under-complying patients report taking all their medication. This combined failure properly to self-administer medication and failure to report accurately about missed doses can lead the physician to misinterpret the patient's medical situation, including: misattribution of a change in the severity of the disease(s), the effectiveness of the prescribed drug(s), and the correct dose(s) thereof for the patient in question. For example, a physician may increase a dose or change drugs upon detecting that a previously prescribed drug regimen has failed to work as expected. However, if the real problem is that the patient has not taken the drug(s), and the treating/prescribing physician is unaware of that fact, then changing the drug(s) or the dose(s) of the drug(s) are not correct solutions to the problem. The manner in which clinically unrecognized poor compliance with prescribed anti-hypertensive medicines has been vividly illustrated by a recent publication from the Hypertension Clinic in Lausanne, Switzerland (Prof. H-R Brunner), in the following paper: Burnier M, Schneider M P, Chiolero A, Fallab Stubi C L, Brunner H R. Electronic compliance monitoring in resistant hypertension: the basis for rational therapeutic decisions. J Hypertens 2001; 19:335-41.

It is now well established, and well known to those skilled in the art, that electronic medication event monitoring, also known in the medical literature as MEMS® Monitoring, is the best available method of compiling the drug dosing histories of ambulatory patients, from which the patient's compliance with the prescribed regimen(s) is determined (1-3). Medication packages, dispensers, or organizers that monitor deviations from a prescribed dosing regimen are described in U.S. Pat. Nos. 4,725,997 and 4,748,600, which are incorporated herein by reference in their entirety. Such medication event monitoring systems (MEMS®) are available from Aardex Ltd. of Zug, Switzerland.

These medication eventmonitoring devices are helpful in reporting to the physician the dosing history of a patient, from which the patient's degree of compliance with the prescribed drug regimen can be determined. Patient compliance is generally defined as the extent to which the patient's recorded dosing history corresponds to the prescribed dosing regimen. The medication event-monitoring devices, which include drug packages, drug dose dispensers, and drug dose organizers, do not, however, help the physician determine what level of compliance with the prescribed dosing regimen is needed to achieve a desired result. Nor do these medication event-monitoring devices provide the physician with a clinically useful analysis of the dosing data or with advice regarding how best to bring the patient into better compliance with the prescribed regimen.

It is also well established in the medical literature, and well-known to those skilled in the art, that the actions of prescription drugs depend upon both the amount (dose) of drug taken, and the time-intervals that elapse between individual doses of drug. The specifics of the dose- and time-dependent actions of drugs vary, not only from one drug to another, but even within the same drug, depending upon how it is formulated (4). Thus, each pharmaceutical product in use poses the question of how best to define its dynamic relations between the history of its dosing and the clinical consequences attributable to the drug's doseand time-dependent actions.

A commonly run diagnostic test is to sample the patient's blood and measure in that same sample the concentration of the drug(s) with which the patient is being treated. This diagnostic test is called ‘therapeutic drug monitoring’ (TDM). The usual practice in TDM is to rely upon the patient's report of when the most recent dose, prior to blood sampling, was taken, and also to rely on the patient's account of how closely he/she complied with the prescribed drug regimen. Relying on patients' self-report of these critical variables introduces a great deal of error into the interpretation of the measured concentration of drug in each blood sample. The use of medication event monitoring data to indicate objectively, and without problems of memory recall or willful exaggeration, the history of drug dosing prior to the blood sample creates the basis for a much less error-prone interpretation of TDM test results. For example, if the patient had taken no drug during the past 72 hours, and if the drug has a plasma half-life of 12 hrs (which is within the range of plasma half-lives of the vast majority of drugs), the concentration of drug in plasma will be virtually zero. The TDM analyst will conclude from the zero value of drug concentration either that drug absorption was poor, or that the drug was unusually rapidly metabolized or excreted, or that the compliance was poor. If the patient asserts punctual compliance with the drug regimen, then the patient's caregivers are logically left to conclude poor absorption or unusually accelerated clearance of the drug from the bloodstream, and either pursue the wild goose-chase of investigating malabsorption and clearance mechanisms, or changing to another drug, which will encounter the same compliance problem unless the patient opts to comply satisfactorily. Meanwhile, money spent on the TDM tests has yielded little useful information. The use of medication event monitoring data can avoid these and other mistakes that will be obvious to those skilled in the art, and thus provide a useful tool to physicians and other caregivers in interpreting TDM tests in full knowledge of when doses were actually taken.

Another environment where medication event monitoring devices are helpful is in clinical trials. When a clinical trial is run, comparison of events and event-rates in two or more groups of patients is a widely used, if not universal approach. A basic maneuver, assuring equipoise in comparisons of occurrences in the various groups, is the prior randomization of patients who meet the various criteria for inclusion into, and exclusion from, the trial. Another basic maneuver, also assuring equipoise in comparisons among the various groups, is blinding, such that those who care for the patients in the several groups are unaware of which treatment they are receiving. One basic check on the quality of a clinical trial is auditing, to be certain that the protocol was correctly followed, usually done retrospectively when it is too late to correct errors and minimize their impact. Electronic monitoring of each patient's time- and date-stamped, dose-by-dose progress through the protocol-described pathway is a primary source documentation of the patient's progress through the protocol-specified sequence of maneuvers in clinical trials testing or involving prescription pharmaceuticals, new or established. Instances of investigator fraud in performing clinical trials have been detected from inspection of the dosing histories that were fraudulently compiled, as described in the following publication: Vander Stichele R H, Thomson M, Verkoelen K, Droussin A M. Measuring patient compliance with electronic monitoring: lisinopril versus atenolol in essential hypertension. Post-marketing Surveillance 6: 77-90, 1992.

### REFERENCES

The following publications are cited in parenthesis in this application. All of the following references are herein incorporated by reference in their entirety to the same extent as if each individual reference was specifically and individually indicated to be incorporated herein by reference in its entirety.

1. Liu H, Golin C E, Miller L G, Hays RD, Beck C K, Sanandaij S, Christian J, Maldonado T, Duran D, Kaplan A, Wenger N S. A comparison study of multiple measures of adherence to HIV protease inhibitors. Ann Inter Med 2001; 134: 968-77.

2. Arnsten J, Demas P, Farzadegan H, Grant R, Gourevitch M, Chang C, Buono D, Eckholt H, Howard A, Schoenbaum E. Antiretroviral therapy adherence and viral suppression in HIV-infected drug users: comparison of self-report and electronic monitoring. Clinical Infectious Diseases 2001; 33: 1417-23.

3. Urquhart J, de Klerk E. Contending paradigms for the interpretation of data on patient compliance with therapeutic drug regimens. Stat Med 17: 251-267, 1998.

4. Urquhart J. Controlled drug delivery: pharmacologic and therapeutic aspects. J Internal Med 248: 357-76, 2000.

### SUMMARY OF THE INVENTION

The present invention relates to a system and method for portal-mediated, website-based analysis of medication dosing compliance.

In accordance with one aspect of the present invention a system for portal-mediated, website-based analysis of medication dosing includes a drug package, dispenser, or organizer including a means for recording actual dispensing times as dosing history data, means for transmitting the dosing history data to a webserver through a website for analysis, means for inputting and transmitting patient data including patient condition and prescribed drug regimen to the webserver through the website, means for analyzing the dosing history data by means provided by the webserver and producing analysis data and advice, means for collecting a fee from an inputting party, and means for transmitting the analysis data and advice to the inputting party from the webserver through the website.

In accordance with a second aspect of the present invention, a system for portal-mediated, website-based analysis of medication dosing includes a package, dispenser, or organizer adapted to provide a patient with medication, and to generate dosing history data, a webserver accessible through a suitably designed portal, and adapted to receive said dosing history data through said portal, via the Internet, and, a processor for analyzing said received dosing history data to thereby generate analyses which can help guide the physician's decision-making regarding-both diagnosis and treatment.

In accordance with another aspect of the present invention, a medication dosage analysis method includes the steps of dispensing medication to a patient during a first set of dispensing events, said first set of dispensing events comprising at least one dispensing event at a first location, generating dosing history data based on said first set of dispensing events, transmitting the dosing history data to a second location remote from the first location via the Internet, and generating analysis data based on the dosing history data at the second location.

In accordance with a further aspect of the present invention, a system for portal-mediated, website-based analysis of medication dosing includes a server for hosting a website accessible through the Internet, said website adapted to provide access to a first location to which dosing history data and patient condition information are sent from one or more locations different from the first location, and a processor for receiving the dosing history data and patient condition information, and for generating analysis data based on the received information.

In accordance with another aspect of the present invention, a medication dosage analysis system includes a package, dispenser, or organizer adapted to provide medication to a patient during a medication event at a first location, and to generate dosing history data relating to said medication event, and a processor remotely located from said medication event, the processor receiving the dosing history data automatically and generating analysis data therefrom.

### BRIEF DESCRIPTION OF THE DRAWING FIGURES

The invention will now be described in greater detail with reference to the preferred embodiments illustrated in the accompanying drawing wherein:

FIG. 1 is a schematic view of a system for portal based analysis of medication dosing data in accordance with the present invention.

### DETAILED DESCRIPTION OF THE INVENTION

The system of portal-mediated, website-based analysis of medication dosing data provides a system for recording dosing history, analyzing the dosing history data, and providing a physician with the analysis of the dosing history data, as well as advice as to the steps to take to improve the patient's compliance or to prevent its future deterioration.

The system includes a drug package, drug dose dispenser, or drug dose organizer, including a means for recording the actual dispensing times as dosing history data; means for transmitting the dosing history data to a portal and thence to a website for analysis; means for inputting and transmitting patient data, including information on the patient's medical condition and prescribed drug regimen, to the website; means for analyzing the dosing history data at the website; means for collecting a fee from an inputting party; and means for transmitting analysis of dosing history and advice to the inputting party from the website. When data on groups of patients with a particular condition are sent to the portal-mediated, website-based analysis mechanism, it is also possible to compare the frequency distributions of certain clinically important variables in the present data set versus those in previously analyzed data sets.

The terms “drug” or “medication” as used herein mean both prescription drugs and over the counter medications for which a dosing schedule has been recommended by a physician or other health care provider, based either on information provided by the drug product's labeling or on special, patient-specific considerations as judged by the prescriber.

The drug package, dispenser, or organizer may include any of the known packages, dispensers, or organizers, including electronic means for recording dispensing time and date for each dose taken. The drug package, dispenser, or organizer may optionally include electronic means for determining the dosage deviation from the prescribed regimen. In the event that the dosage deviation is not determined by the package, dispenser, or organizer, it may be determined by a local or remote computer.

The drug package, dispenser, or organizer is coupled to a personal computer, such as a computer in the physician's office by a coupling means, which may be in the form of a communicator. For example, the package or dispenser may be coupled electronically, optically, by cellular telephone, by wireless network, or by any other coupling means for delivery of dosing history data to the website. Alternatively, the package or dispenser may be coupled to a base station or communicator near the patient, such as in the patient's home, and the data may be downloaded automatically or manually on a desired schedule into the base station. The data are then transmitted from the base station to the computer at the physician's office or to the website. The delivery of data from the drug package, dispenser, or organizer to a base station and from the base station to the physician's office allows monitoring of the patient's dosing history by the physician between office visits and removes reliance on the patient to bring the drug package, dispenser, or organizer to the physician at each office visit.

A webserver accessible through a website performs analysis of dosing history data based on one of several models. On the most basic level, the dosing history data may be assembled into a useable format and/or compared to the prescribed dosing regimen by the webserver, and compliance data may be returned to the physician, pharmacist, or other caregiver for analysis. However, the dosing history data are preferably analyzed by the webserver to ascertain a predicted effect of the patient's compliance level on the drug's actions. The dosing data may be compared to a basic population model for the particular drug and dose. This model does not take into account the specifics of the particular patient involved but provides an indication of whether the dosage deviation (compliance) by a particular patient would tend to have the desired effect, i.e. improvement of condition, or prevention of worsening of condition, whether effectiveness would be compromised, or whether particular temporal patterns of deviantly compliant drug intake might be hazardous.

Another model which may be used is a patient-specific model which includes not only the data from the population model, but also includes results of therapeutic drug monitoring or other tests on the specific patient to determine the effects of the drug(s) in question at particular degrees of compliance with the prescribed drug regimen(s).

The population model can evolve into a patient-specific model with additional data and experience gathered over time. The patient-specific model has parameter values unique to the patient in question, and validated by prior experience in simulating drug responses and time-varying concentrations of drug in plasma. The patient-specific model for each patient will be periodically fine-tuned and individualized over time as additional patient-specific data are added to the website database.

The models for analyzing dosing history data may include pharmacokinetic (PK) and pharmacodynamic (PD) models, which may be periodically updated, based on the additional information, especially but not limited to the clinical correlates of the patient's dosing history data. The models may also incorporate pharmacogenomic information, when available and pertinent. For example, the pharmacogenomic model determines a patient's genetic makeup, and uses that information as a basis for individualized adjustment of dose and dose timing.

These models are examples of the models that may be used to analyze the dosing history data and provide advice to the physician regarding a recommended course of action.

Once the analysis is performed according to any one of these model-based analyses, the results, subject to due precautions, described elsewhere, regarding maintenance of privacy, are sent from the webserver back to the physician via the internet or other medium. The results may be in the form of tables, graphs, or other statistics, which provide an indication of the degree to which the patient complied with the prescribed drug regimen.

The information returned from the webserver to the physician via the website also preferably includes advice for the physician on a recommended course of action. The advice may include the expected consequences of the deviations in compliance. The results may also include an indication of an amount of improvement in compliance that is estimated to elicit the desired result, i.e. improvement in, or no further deterioration of, the patient's condition. The website may also provide recommendations for improved compliance, for example, a recommendation that the caregiver take an inventory of the patient's daily routines, select what appears to be the most robust of these routines, and show the patient how to couple the act of dosing to that routine. Those skilled in the art will recognize that such advice is an application of the method of Cramer and Rosenheck (Cramer J A, Rosenheck R. Enhancing medication compliance for people with serious mental disease. J Nervous Mental Dis 187: 53-4, 1999.) On the other hand, if several such routines have been tried, without the achievement of satisfactory compliance, then the next level of advice may take the form of advising a change in the prescribed drug from a less to a more forgiving pharmaceutical that is better able to maintain therapeutic drug action in the face of intermittent lapses in dosing. If that maneuver fails to achieve desired results—always based on ongoing measurement and analysis of data—then the recommendation might be to enter the patient into a program of ‘directly observed therapy’, in which the administration of each dose of medicine is witnessed by a caregiver. Another option is to abandon drug treatment on the grounds that the patient's incapability to dose correctly will result in more harm than good.

Those skilled in the art will recognize that, though the details may differ from one medical situation and patient to another, the portal-mediated, website-based compliance monitoring system incorporates (a) ongoing compilation of the patient's dosing history, (b) ongoing analysis of said data, (c) recommendation of action suitable for the patient's then-current situation communicated to a physician or other supervising party. The generation of advice may be fully automated and generated by software and/or may include expert advice given by a staff member experienced in the analysis of pharmaceutical dosing.

The fees charged for services performed by the website may depend on the services performed, the number of patients, or many other factors. The fees may be collected for each transaction or on a periodic basis. Fees may be collected through the website or separate from the website, such as by mail or facsimile.

The system of the present invention also includes a portal for performing certain functions as information passes between a webserver and a user. The portal provides a point of access or interface and can perform an array of functions including maintaining privacy, identify removal, identity reattachment, verification of credit, estimation of costs, payment processing, and virus detection and protection. The portal serves as the role of sentinel or guardian to protect the data and the patient privacy.

The portal-mediated, website-based system is used to analyze and gather patient data while maintaining confidentiality of patient data. According to one preferred embodiment of the invention, the patient data inputted by a physician is identified by a patient name, birth date, and/or other identifying information. However, the patient identity is removed by the portal from the patient data and there replaced by a patient code for purposes of subsequent analysis and generation of advice; this change in patient identifier is preferably done by the portal, but may be done by a separate server or processor. The patient identity is rejoined with the analysis and advice during the return of the data to the physician, as the data pass from the website through the portal. In this manner, the anonymity of patient data are assured during the process of data analysis, all of which takes place behind the portal, within the website. The global characteristic of such data analysis is that some aspects of the data are retained within the website to facilitate analysis and interpretation of future sets of data. Anonymity is assured by the algorithm that removes specific patient identifiers, substituting them for an anonymous code, as the data pass through the website's portal, with the reverse substitution occurring as the analyzed, anonymized data pass out through the website's portal.

Other known methods may also be used to ensure privacy of patient, physician information and payment, including encryption and other security measures. Alternative methods of maintaining patient privacy may include blocking of patient identity information.

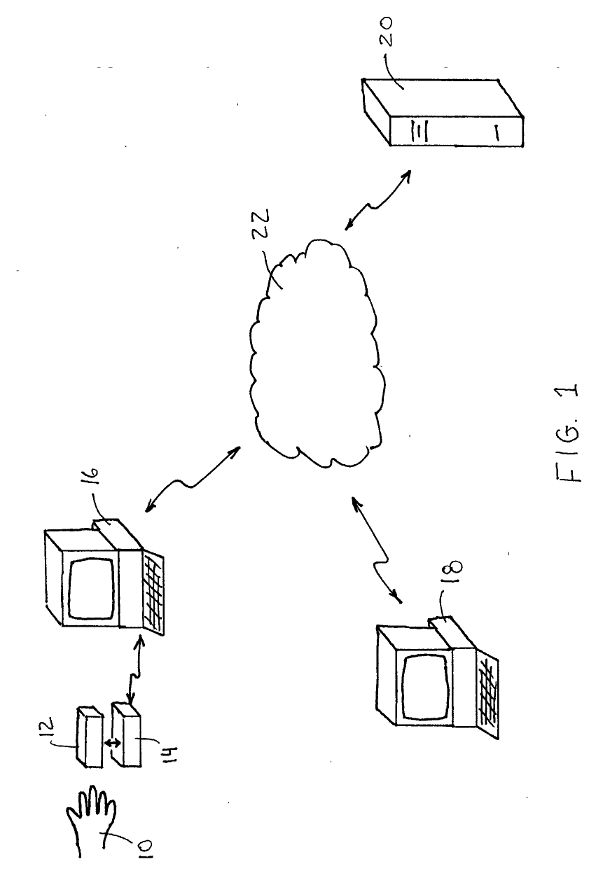

FIG. 1 shows a system in accordance with the invention. A patient 10 uses a drug package, dispenser, or organizer from which to acquire medication. The package or dispenser 12 is adapted to track its dispensing activities, for example storing dosing history data, such as time and dose of each dispensing event, in a memory (not shown) provided within or attached to the package or dispenser. Details of the dispensing tracking feature do not form a part of the invention and are omitted. However, examples of packages or dispensers are described in U.S. Pat. Nos. 4,725,997 and 4,748,600, which have been previously incorporated by reference.

A communicator or base station 14 connected to a PC (personal computer) 16 interfaces with package or dispenser 12. Communicator 14 electronically mates with package or dispenser 12, such that unidirectional or bi-directional information exchange between the communicator and the package or dispenser can take place. Specifically, the stored dosing history data can be dumped from the memory of package or dispenser 12 into PC 16 via communicator 14. Electronic mating can be by means of physical contact of electrical leads, or wirelessly, via capacitative or inductive coupling, or via radio waves or light/infrared signals. In this manner communicator 14 can serve as a docking station to which package or dispenser 12 is physically or wirelessly mated for information exchange.

PC 16 operates as a communication link to one or more remote stations. One such remote station is a PC 18 provided at a physician location. Another such remote station is a server 20, such as a webserver hosting the portal website designed to provide the analysis services discussed above. In particular, server 20 operates as a processing device which analyzes the received dosing history data and any information provided to the system by the physician and thereby generates analysis data used for a patient, including dosage histories, analysis of expected results of dosage history, treatment advice, and recommendations. Alternatively, a separate processor can be used to generate analyzed data and to formulate the patient profile, which is then passed on to the physician through the server 20, or through other means, such as an e-mail server (not shown), facsimile, and so forth. It is also contemplated that a human care provider can generate the analysis data and/or the patient profile, and particularly the diagnoses and recommendations for the course of treatment.

It will be appreciated that PC 16 at the patient location can be eliminated. Instead, communicator 14 can serve to establish a direct communication link with the remote stations including the PC 18 or the server 20, using for example a standard modem operating over telephone lines, or via a wireless connection, or via dedicated or public cable lines, and so forth. Alternatively, package or dispenser 12 itself can be used to directly transmit dosing history data, wirelessly or through a modem-type connection, to stations such as PC 18 and server 20.

Communication between devices can be effected through one or more networks. Internet 22 is shown as providing one communication medium, which can be, navigated conventionally using browsers (not shown) provided on PCs 16 and 18. Using said browsers, a website hosted by server 20, which can be a single server or a cluster of such servers and related peripheral devices (not shown), can be accessed. The dosing history data are then uploaded from the user location to the website through Internet 22. Other information, identifying the particular user/patient, may also be provided. The extent of such information will likely depend on the particular session—for example, in the first such session, more information will be needed than in subsequent sessions. It will also be appreciated that while the example of FIG. 1 relates to use of the Internet as the medium for the exchange of information, other networks, for example intranets, or wireless cellular networks, or combinations of such networks, can be used without departure from the spirit and scope of the invention.

In the event that one of the communication links is disrupted, the package or dispenser 12 retains the dosing history data for later download. In the event of failure of communication for a specified period, depending on an urgency of treatment, a warning may be provided to a physician or other supervising party to contact the user.

Also uploaded to the host website is information on the patient's condition, provided from the physician location. This information will primarily be medical in nature, relating to the patient's physical and medical condition, prognosis, and prescribed treatment, for instance. Information relating to payment for the services of the host website can also be provided, and may include patient insurance information. Payment information may also be provided by the user/patient in some circumstances.

Upon receiving all the information from the user/patient and the physician, the host website can perform the analyses described above and generate reports pertaining to dosing history, as well as determine recommended courses of treatment. This information can be accessed by the physician, through the browser provided on PC 18, who can use it to suitably treat the patient 10. Alternatively or additionally, the information can be sent to the physician, through e-mail, or through conventional means such as post, facsimile, and so forth.

The analysis or reports which may be provided by the website include a Calendar Plot® which indicates the number of doses taken each day, a chronology plot which is a graphical representation of days and times of doses, a frequency histogram, or other numerical or graphic information. The advice and recommended course of action may include analysis of the expected consequences of deviations from prescribed dosing including the probability the patient will improve or deteriorate; an analysis of an amount of improvement in compliance which is estimated to elicit the desired result; a recommendation of changes in routines to improve compliance; a recommendation of change in drug or dosing regimen to improve compliance or reduce side effects.

The system of portal-mediated, website-based analysis of medication dosing also has significant advantages for use in clinical trials. Electronic monitoring of each patient's dose-by-dose progress throughout a clinical trial allows the early identification of poor compliance, errors in dosing instructions, continually decreasing compliance, or other problems, which may result in removal of data from the study. By continuous monitoring, certain steps can be taken to correct dosing errors without breaking the randomization code or unblinding the study. The steps that may be taken include correction of incorrect dosing instructions or across the board incentives and motivational maneuvers to improve compliance and minimize dropouts.

The use of the website-hosted server 20 to perform the analysis of the dosing history data provides several advantages. Primarily, the analysis software can be updated and maintained more easily when the software is confined to one or a small number of locations. In addition, fees may be collected by the website and pricing plans may be changed easily. The fees may be based on amount of data submitted, fees for different services, fees per submission, and/or fees for monthly subscription services.

Another significant advantage of the use of the server hosted website to perform analysis is that the models used for analysis can be continually or periodically updated with the additional data from the patients using the website and/or other data which becomes available from other sources and studies.

While the invention has been described in detail with reference to the preferred embodiments thereof, it will be apparent to one skilled in the art that various changes and modifications can be made and equivalents employed, without departing from the present invention.

What is claimed is:

1. A system for portal-mediated, website-based analysis of medication dosing, the system comprising:
a drug package, dispenser, or organizer including a means for recording actual dispensing times as dosing history data;
means for transmitting the dosing history data to a webserver through a website for analysis;
means for inputting and transmitting patient data including patient condition and prescribed drug regimen to the webserver through the website;
means for analyzing the dosing history data by means provided by the webserver and producing analysis data and advice;
means for collecting a fee from an inputting party; and
means for transmitting the analysis data and advice to the inputting party from the webserver through the website.

2. A system for portal-mediated, website-based analysis of medication dosing, the system comprising:
a package, dispenser, or organizer adapted to provide a patient with medication, and to generate dosing history data;
a webserver accessible through a website and adapted to receive said dosing history data through said website via the Internet; and
a processor for analyzing said received dosing history data to thereby generate analysis data.

3. The system of claim 2, wherein the webserver and processor are components of a single device.

4. The system of claim 2, wherein the analysis data generated from the dosing history data includes a graphical representation of days and times of doses.

5. The system of claim 2, wherein the processor generates advice.

6. The system of claim 2, wherein the advice comprises treatment modification recommendations; medication or dosage modification recommendations; or counseling recommendations.

7. The system of claim 3, wherein the patient profile is sent to a remote location through the Internet, facsimile, and/or postage.

8. The system of claim 2, further including a communicator through which the package, dispenser, or organizer communicates with the webserver to thereby provide the dosing history data.

9. The system of claim 7, further including a personal computer disposed at the remote location, the personal computer receiving the patient profile by accessing said website through the Internet.

10. The system of claim 2, further including a personal computer through which payment information is sent to the website.

11. The system of claim 9, wherein the personal computer is at a patient's location.

12. The system of claim 9, wherein the personal computer is at a physician's location.

13. The system of claim 2, comprising anonyminity software which removes or blocks patient identity data during analysis of the dosing history data by the webserver and replaces the patient identity data for delivery to a physician

14. A medication dosage analysis method comprising:
dispensing medication to a patient during a first set of dispensing events, said first set of dispensing events comprising at least one dispensing event at a first location;
generating dosing history data based on said first set of dispensing events;
transmitting the dosing history data to a second location remote from the first location via the Internet;
generating analysis data based on the dosing history data at the second location.

15. The method of claim 14, wherein the dosing history data includes medication dispensing time and dosage.

16. The method of claim 14, wherein patient profile data are transmitted from a third location to the second location, and the analysis data are generated based on the patient profile data and the dosing history data.

17. The method of claim 16, wherein the patient profile data includes information relating to compliance with a predetermined dispensing regimen, defined by pharmaceutical product labeling, by the prescribing physician's clinical judgment, or by results of prior analysis of the patient's dosing history data and its clinical correlates.

18. The method of claim 14, wherein the dosing history data are transmitted in encrypted format.

19. The method of claim 14, comprising transmitting payment information from a third location to the second location.

20. The method of claim 11, further comprising sending the analysis data to a third location remote from the second location.

21. The method of claim 20, wherein said sending is conducted over the Internet.

22. The method of claim 14, wherein said generating is conducted automatically.

23. The method of claim 14, wherein said generating is conducted by a human operator.

24. The method of claim 14, wherein patient identity data are removed or suppressed during generation of the analysis data.

25. A system for portal-mediated, web-based analysis of medication dosing comprising:
a server for hosting a website accessible through the Internet, said website adapted to provide access to a first location to which dosing history data and patient condition information are sent from one or more locations different from the first location; and
a processor for receiving the dosing history data and patient condition information, and for generating analysis data based on the received information.

26. The system of claim 25, wherein the processor is further adapted to receive payment information.

27. The system of claim 25, wherein the server and processor are components of a single device.

28. The system of claim 25, wherein the processor further generates advice from the dosing history data and patient condition information.

29. A medication dosage analysis system comprising:
a package, dispenser, or organizer adapted to provide medication to a patient during a medication event at a first location, and to generate dosing history data relating to said medication event; and
a processor remotely located from said medication event, the processor receiving the dosing history data automatically and generating analysis data therefrom.

30. The system of claim 29, wherein the analysis data include one or more of graphical representations of dosing history, treatment advice, and recommendations about medication or dosage modification.

31. The system of claim 30, wherein the analysis data are sent to a remote location through the Internet.

32. The system of claim 30, wherein the analysis data include information relating to compliance with a predetermined dosing regimen.

33. The system of claim 29, wherein the analysis data provide an indication of the impact of deviation from a predetermined dosing regimen.

34. The system of claim 29, wherein the dosing history data are transmitted in encrypted format over the Internet.

35. The system of claim 29, wherein the processor receives patient condition information from a second location remote from the first location and from the location of the processor.

36. The system of claim 35, wherein the analysis data are further based on the patient condition information.

37. The system of claim 29, wherein the processor receives payment information.

38. The system of claim 37, wherein the payment information is received from a second location.

39. The system of claim 29, wherein the analysis data are formulated automatically.

40. The system of claim 29, wherein the analysis data are formulated by a human operator.

41. The system of claim 29, further comprising a portal receiving the dosing history data from the package, dispenser, or organizer and forwarding the dosing history data to the processor, wherein the portal removes a patient identify from the dosing history data.
